(19) United States
(12) Patent Application Publication
(10) Pub. No.: US 2005/0183080 A1
(43) Pub. Date: Aug. 18, 2005

(54) Portable electronic apparatus and method of dynamic data processing

(76) Inventors: Jing-Shun Lin, Wujie Township (TW); Ying-Hao Hsu, Keelung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/037,911

(22) Filed: Jan. 18, 2005

(30) Foreign Application Priority Data
Feb. 18, 2004 (TW) 93103867

(51) Int. Cl. G06F 17/00; G06F 12/00

(52) U.S. Cl. 717/168; 711/165

(57) ABSTRACT

A portable electronic apparatus and a method of dynamic data processing. The portable electronic apparatus has a processing unit, a random access memory (RAM) and a read-only memory (ROM). The ROM has a compressed data storage region and a dynamic data storage region, and compressed program data is stored in the compressed data storage region. The processing unit retrieves the compressed program data from the compressed data storage region and decompresses the compressed program data to obtain a decompressed program data. The decompressed program data is stored in the RAM during decompression. When the decompression is complete, the decompressed program data stored in the RAM is retrieved and written to the dynamic data storage region of the ROM.

### BACKGROUND OF THE INVENTION

1. Field of the Invention

The present invention relates to a portable electronic apparatus and a method of dynamic data processing.

2. Description of the Related Art

In recent years, various portable electronic apparatuses, such as digital and video cameras, cellular phones, and notepad dictionaries, are commonly used to perform a variety of different tasks, such as digital photography, wireless communication, and others. Additionally, portable-electronic apparatuses may provide a plurality of additional functions. Generally, these additional functions are controlled by firmware and stored in the memory of the portable electronic apparatus.

For example, FIG. 1 shows components of a conventional portable electronic apparatus. In FIG. 1, the portable electronic apparatus, e.g. a digital camera, has a CPU 110 as a processing unit, and various types of memory. The CPU 110 can be an application specific integrated circuit (ASIC) The memory includes a read-only memory (ROM) 120 for storing firmware which cannot be rewritten by a general data storage process, a random access memory (RAM) 130 for storing erasable data, and a detachable external storage 140, such as a memory card for the digital camera. Generally, the additional functions of the digital camera are written to the ROM 20 in the form of firmware.

It is well known that data storage capacity is limited by the size of the memory. Accordingly, if the designer of the portable electronic apparatus intends to provide additional complicated functions, the memory, i.e. the ROM 120 in FIG. 1 must be increased to store the firmware which requires increased data capacity. The size of the memory in a portable electronic apparatus, however, is strictly limited by space considerations and cost. Thus, additional functions of the portable electronic apparatus are limited.

Generally, program data for additional functions can be stored in an external storage 140. In this case, however, addition of external storage 140 is cost-prohibitive.

### SUMMARY OF THE INVENTION

Accordingly, an object of the present invention is to provide a portable electronic apparatus and a method of dynamic data processing, capable of dynamically modifying program data for additional functions provided by the portable electronic apparatus without requiring increased memory.

The present invention discloses a method of dynamic data processing, for use in a portable electronic apparatus. A portable electronic apparatus comprising a random access memory (RAM) and a read-only memory (ROM) is provided. The ROM has a compressed data storage region and a dynamic data storage region. Compressed program data is stored in the compressed data storage region. The compressed program data is retrieved and decompressed to obtain decompressed program data. The decompressed program data is stored in the RAM during decompression. When complete, the decompressed program data stored in the RAM is retrieved and written to the dynamic data storage region of the ROM.

The present invention further discloses a portable electronic apparatus, comprising a read-only memory (ROM) and a processing unit. The ROM has a compressed data storage region and a dynamic data storage region. Compressed program data is stored in the compressed data storage region. The processing unit retrieves and decompresses the compressed program data to obtain decompressed program data. Preferably, the portable electronic apparatus has a random access memory (RAM), and the decompressed program data is stored in the RAM during decompression. When decompression is complete, the processing unit retrieves and writes the decompressed program data to the dynamic data storage region of the ROM.

Preferably, in the present invention, an external storage capable of detachable connection to the processing unit of portable electronic apparatus is provided, and compressed program data can be stored therein. Thus, the processing unit can retrieve and decompress the compressed program data from the external storage, and store it as mentioned above.

The external storage can be a memory card. The processing unit can be an application specific integrated circuit (ASIC). The ROM can be an external ROM.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view showing a conventional portable electronic apparatus;

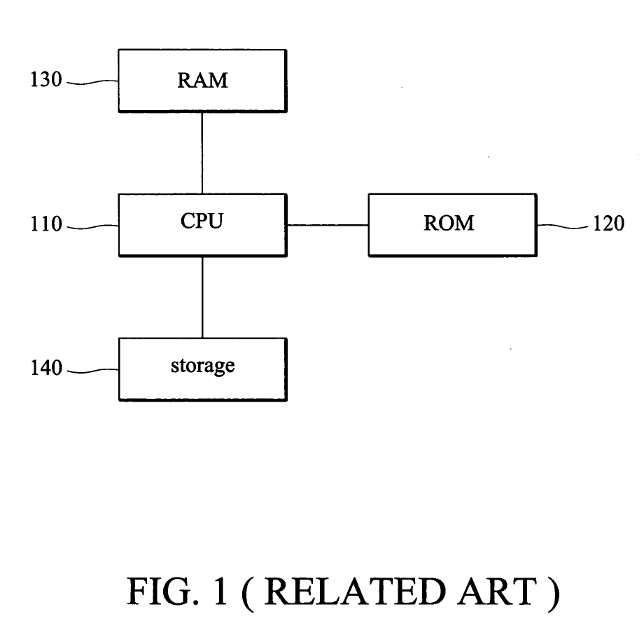

FIG. 2 is a schematic view showing an embodiment of the portable electronic apparatus of the present invention; and

FIG. 3 is a flow chart showing the method of dynamic data processing of the present invention.

### DETAILED DESCRIPTION OF THE INVENTION

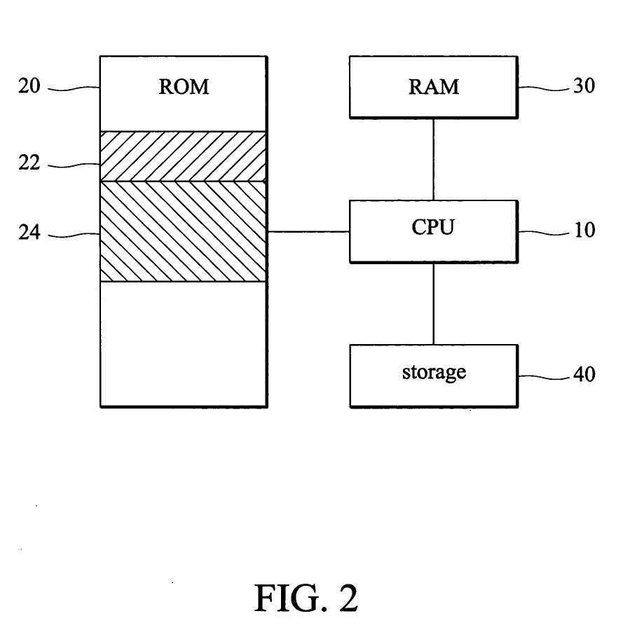

The present invention discloses a portable electronic apparatus. The portable electronic apparatus can be a digital camera, video camera, cellular phone, PDA, or any other type of portable electronic apparatus. An embodiment of a digital camera given as an example is hereinafter described with reference to FIG. 2.

IN FIG. 2, the digital camera has a CPU 10, e.g. an ASIC, as a processing unit, and various types of memory. The memory includes a ROM 20 and a RAM 30, respectively connected to the CPU 10. The ROM 20 can be an external ROM, and the RAM 30 can be SDRAM. Further, an external storage 40, e.g. a memory card, is provided for the digital camera in FIG. 2.

According to the embodiment, the ROM 20 has a compressed data storage region 24 and a dynamic data storage region 22. The compressed data storage region 24 is a reserved region in which compressed program data is stored. The compressed program data comprises compressed files of the program data for additional functions of the digital camera, such as a game program. Data stored in the compressed data storage region 24 can be retrieved by the CPU 10 for decompression. Thus, decompressed program data can be obtained and written to the dynamic data storage region 22 for execution. Further, the RAM 30 serves as a register for the decompressed program data in the CPU 10.

With the above-described structure of the digital camera, the program data for additional functions can be compressed and stored in the compressed data storage region 24 when not in use. When a specific additional function is used, the CPU 10 retrieves the compressed program data from the compressed data storage region 24 and decompresses the compressed program data to obtain decompressed program data. The decompressed program data is stored in the RAM 30 during decompression. When decompression is complete, the decompressed program data stored in the RAM 30 is retrieved and written to the dynamic data storage, region 22 of the ROM 20. Thus, the memory size of ROM 20 can be optimally utilized to provide an increased variety of additional functions.

It should be noted that data in the ROM 20 is not erasable. Thus, the process for writing decompressed program data to the dynamic data storage region 22 of the ROM 20 is different from the data storage process for the RAM 30 or the external storage 40.

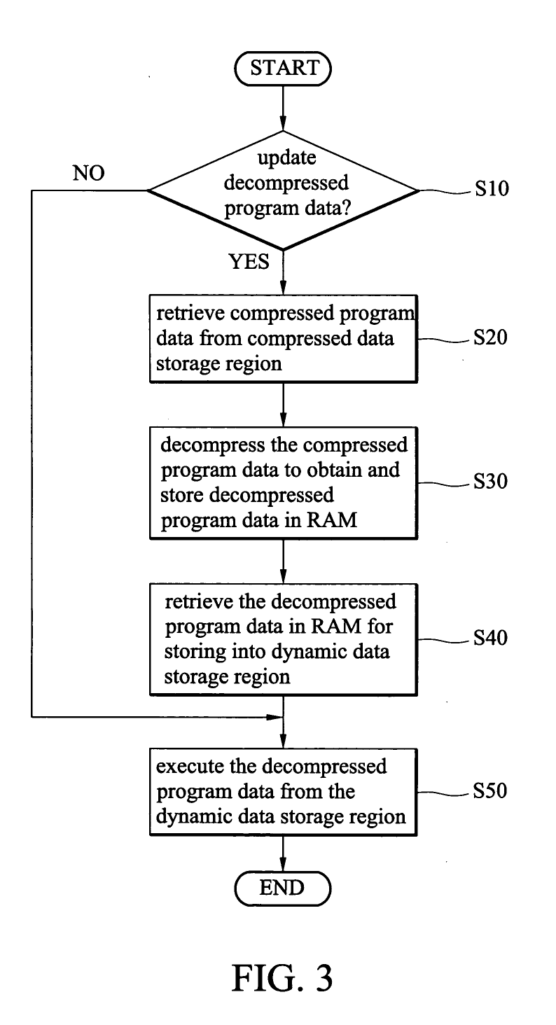

Further, the method of dynamic data processing for the portable electronic apparatus of the present invention is described with reference to the flow chart of FIG. 3.

When using one of the additional functions provided by a portable electronic apparatus, such as the digital camera shown in FIG. 2, such as a game program, the CPU is 10 (i.e. the processing unit) checks the decompressed program data in the dynamic data storage region 22.

When the decompressed program data in the dynamic data storage region 22 is different from the program to be used, the decompressed program data must be updated (step S10). Thus, the CPU 10 retrieves the compressed program data from the compressed data storage region 24 (step S20), and, decompresses the compressed program data to obtain decompressed program data. The decompressed program data is stored in the RAM 30 (step S30). When decompression is complete, the decompressed program data in the RAM 30 is retrieved and written to the dynamic data storage region 22 (step S40). Accordingly, the decompressed program data can be executed, from the dynamic data storage region 22 (step S50).

When the decompressed program data in the dynamic data storage region 22 is the same as the program to be used, the decompressed program data does not require update, and the decompressed program data in the dynamic data storage region 22 can be directly executed (step S50).

It is noted that the compressed program data in the embodiment is stored in the compressed data storage region 24 of the ROM 20. The compressed program data, however, can be stored in the external storage 40, e.g. the memory card. In this case, the CPU 10 can retrieve the compressed program data from the external storage 40, and decompress the compressed program data and storing it as mentioned above.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method of dynamic data processing, comprising the steps of:
providing a portable electronic apparatus comprising a random access memory (RAM) and a read-only memory (ROM), the ROM comprising a compressed data storage region and a dynamic data storage region, wherein a compressed program data is stored in the compressed data storage region;
retrieving the compressed program data from the compressed data storage region, decompressing the compressed program data to obtain a decompressed program data, and storing the decompressed program data to the RAM;
retrieving the decompressed program data from the RAM and writing the decompressed program data to the dynamic data storage region of the ROM; and
executing the decompressed program data from the dynamic data storage region.

2. The method of dynamic data processing as claimed in claim 1, further comprising the steps of:
connecting an external storage to the portable electrical device, the compressed program data stored in the external storage; and
retrieving the compressed program data from the external storage, decompressing the compressed program data to obtain the decompressed program data, and storing the decompressed program data to the RAM.

3. The method of dynamic data processing as claimed in claim 2, wherein the external storage comprises a memory card.

4. The method of dynamic data processing as claimed in claim 1, wherein the processing unit comprises an application specific integrated circuit (ASIC).

5. The method of dynamic data processing as claimed in claim 1, wherein the ROM comprises an external ROM.

6. The method of dynamic data processing as claimed in claim 1, wherein the compressed program data comprises a compressed game program.

7. A portable electronic apparatus, comprising:
a read-only memory (ROM) comprising a compressed data storage region and a dynamic data storage region, wherein a compressed program data is stored in the compressed data storage region; and
a processing unit connected to the ROM, the processing unit retrieving the compressed program data from the compressed data storage region, decompressing the compressed program data to obtain a decompressed program data, and writing the decompressed program data to the dynamic data storage region of the ROM.

8. The portable electronic apparatus as claimed in claim 7, further comprising a random access memory (RAM) connected to the processing unit, the RAM storing the decompressed program data during decompression of the processing unit.

9. The portable electronic apparatus as claimed in claim 7, further comprising an external storage detachably connected to the processing unit and storing the compressed program data.

10. The portable electronic apparatus as claimed in claim 9, wherein the external storage comprises a memory card.

11. The portable electronic apparatus as claimed in claim 7, wherein the processing unit executes the decompressed program data from the dynamic data storage region of the ROM.

12. The portable electronic apparatus as claimed in claim 7, wherein the processing unit comprises an application specific integrated circuit (ASIC).

13. The portable electronic apparatus as claimed in claim 7, wherein the ROM comprises an external ROM.

14. The portable electronic apparatus as claimed in claim 7, wherein the compressed program data comprises a compressed game program.
